(19) United States
(12) Patent Application Publication
(10) Pub. No.: US 2018/0197084 A1
(43) Pub. Date: Jul. 12, 2018

(54) CONVOLUTIONAL NEURAL NETWORK SYSTEM HAVING BINARY PARAMETER AND OPERATION METHOD THEREOF

(71) Applicant: ELECTRONICS AND TELECOMMUNICATIONS RESEARCH INSTITUTE, Daejeon (KR)

(72) Inventors: Ju-Yeob KIM, Daejeon (KR); Byung Jo KIM, Sejong (KR); Jin Kyu KIM, Sejong (KR); Mi Young LEE, Daejeon (KR); Seong Min KIM, Daejeon (KR); Joo Hyun LEE, Daejeon (KR)

(21) Appl. No.: 15/866,351

(22) Filed: Jan. 9, 2018

(30) Foreign Application Priority Data
Jan. 11, 2017 (KR) 10-2017-0004379

(51) Int. Cl. G06N 3/08; G06N 3/04

(52) U.S. Cl. CPC G06N 3/084; G06N 3/04

(57) ABSTRACT

Provided is a convolutional neural network system. The system includes an input buffer configured to store an input feature, a parameter buffer configured to store a learning parameter, a calculation unit configured to perform a convolution layer calculation or a fully connected layer calculation by using the input feature provided from the input buffer and the learning parameter provided from the parameter buffer, and an output buffer configured to store an output feature outputted from the calculation unit and output the stored output feature to the outside. The parameter buffer provides a real learning parameter to the calculation unit at the time of the convolution layer calculation and provides a binary learning parameter to the calculation unit at the time of the fully connected layer calculation.

### CROSS-REFERENCE TO RELATED APPLICATIONS

This U.S. non-provisional patent application claims priority under 35 U.S.C. § 119 of Korean Patent Application No. 10-2017-0004379, filed on Jan. 11, 2017, the entire contents of which are hereby incorporated by reference.

### BACKGROUND

The present disclosure relates to a neural network system, and more particularly, to a convolutional neural network system having a binary parameter and an operation method thereof.

Recently, Convolutional Neural Network (CNN), which is one of Deep Neural Network techniques, is actively studied as a technology for image recognition. The neural network structure shows excellent performance in various object recognition fields such as object recognition and handwriting recognition. In particular, the CNN provides very effective performance for object recognition.

The CNN model includes a convolution layer for generating a pattern and a Fully Connected layer (hereinafter referred to as an FC layer) for classifying the generated pattern into learned object candidates. The CNN model performs an estimation operation by applying learning parameters (or weights) generated in the learning process to each layer. At this time, each layer of the CNN multiplies inputted data by a weight, adds the results, activates the result (ReLU or Sigmod calculation), and transfers the result to the next layer.

In the convolution layer, the amount of calculation is relatively large because the learning or convolution calculation of a parameter is performed by a kernel. On the other hand, the FC layer performs the task of sorting the data generated from the convolution layer by object types. The amount of learning parameters of the FC layer accounts for more than 90% of the total learning parameters of the CNN. Therefore, in order to increase the operation efficiency of the CNN, it is necessary to reduce the size of the learning parameter of the FC layer.

### SUMMARY

The present disclosure provides a method and device for reducing the amount of learning parameters required for an FC layer in a CNN model. The present disclosure also provides a method for performing a recognition task by converting a learning parameter into a binary variable (‘−1’ or ‘1’) in an FC layer. The present disclosure also provides a method and device for changing a learning parameter of an FC layer to a binary form to reduce the cost of managing learning parameters.

An embodiment of the inventive concept provides a convolutional neural network system. The system includes an input buffer configured to store an input feature, a parameter buffer configured to store a learning parameter, a calculation unit configured to perform a convolution layer calculation or a fully connected layer calculation by using the input feature provided from the input buffer and the learning parameter provided from the parameter buffer, and an output buffer configured to store an output feature outputted from the calculation unit and output the stored output feature to the outside. The parameter buffer provides a real learning parameter to the calculation unit at the time of the convolution layer calculation and provides a binary learning parameter to the calculation unit at the time of the fully connected layer calculation.

In an embodiment of the inventive concept, an operation method of a convolutional neural network system includes: determining a real learning parameter through learning of the convolutional neural network system; converting a weight of a fully connected layer of the convolutional neural network system in the real learning parameter to a binary learning parameter; processing an input feature through a convolution layer calculation applying the real learning parameter; and processing a result of the convolution layer calculation through a fully connected layer calculation applying the binary learning parameter.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram showing a CNN system according to an embodiment of the inventive concept;

FIG. 2 is an exemplary view of layers of a CNN according to an embodiment of the inventive concept;

FIG. 3 is a block diagram briefly illustrating a method of applying learning parameters of the inventive concept;

FIG. 4 is a view illustrating a node structure of a convolution layer of FIG. 3;

FIG. 5 is a view illustrating a node structure of a fully connected layer of FIG. 3;

FIG. 6 is a block diagram illustrating a calculation structure of a node constituting a fully connected layer according to an embodiment of the inventive concept;

FIG. 7 is a block diagram illustrating a hardware structure for executing a logic structure of FIG. 6 described above; and

FIG. 8 is a flowchart illustrating an operation method of a CNN system that applies a binary learning parameter according to an embodiment of the inventive concept.

### DETAILED DESCRIPTION

In general, a convolution calculation is a calculation for detecting a correlation between two functions. The term “Convolutional Neural Network (CNN)” refers to a process or system for performing a convolution calculation with a kernel indicating a specific feature and repeating a result of the calculation to determine a pattern of an image.

In the following, embodiments of the inventive concept will be described in detail so that those skilled in the art easily carry out the inventive concept.

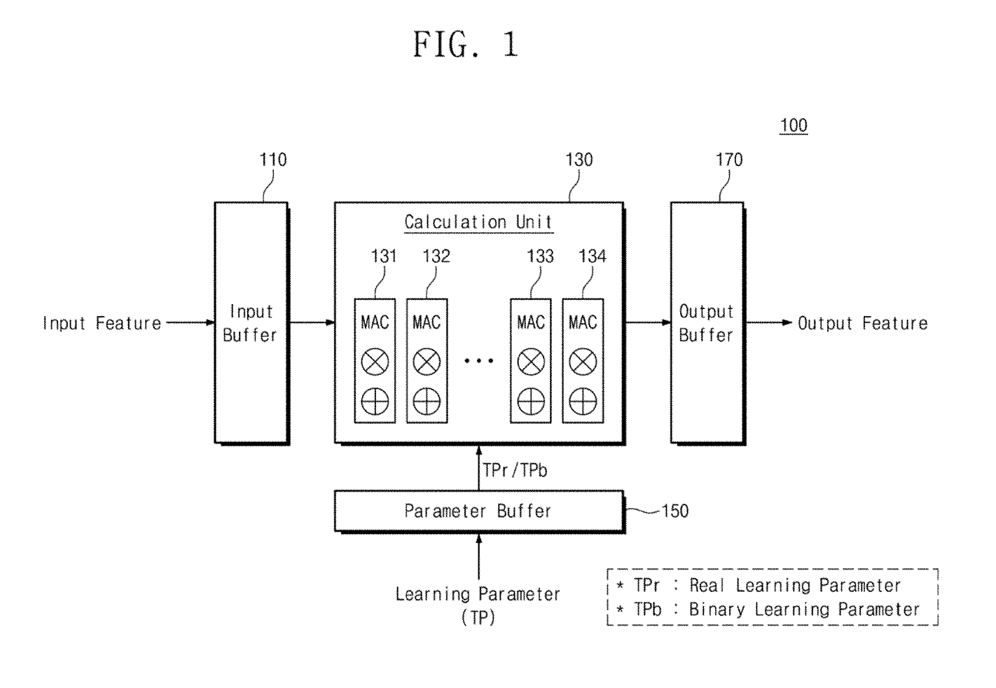

FIG. 1 is a block diagram showing a CNN system according to an embodiment of the inventive concept. Referring to FIG. 1, a neural network system according to an embodiment of the inventive concept is provided with essential components for implementing hardware such as a Graphic Processing Unit (GPU) or a Field Programmable Gate Array (FPGA) platform, or a mobile device. The CNN system 100 of the inventive concept includes an input buffer 110, a calculation unit 130, a parameter buffer 150, and an output buffer 170.

The input buffer 110 is loaded with the data values of the input features. The size of the input buffer 110 may vary depending on the size of a weight for the convolution calculation. For example, the input buffer 110 may have a buffer size for storing input features. The input buffer 110 may access an external memory (not shown) to receive input features.

The calculation unit 130 may perform the convolution calculation using the input buffer 110, the parameter buffer 150, and the output buffer 170. The calculation unit 130 processes, for example, multiplication and accumulation of input features and kernel parameters. The calculation unit 130 may process a plurality of convolution layer calculations using a real learning parameter TPr provided from the parameter buffer 150. The calculation unit 130 may process a plurality of fully connected layer calculations using a binary learning parameter TPb provided from the parameter buffer 150.

The calculation unit 130 generates a pattern of the input feature (or input image) through calculations of the convolution layer using the kernel including the real learning parameter TPr. At this point, weights corresponding to the connection strengths to the nodes constituting each convolution layer will be provided as the real learning parameter TPr. And, the calculation unit 130 performs calculations of the fully connected layer using the binary learning parameter TPb. Through the calculations of a fully connected layer, the inputted patterns will be classified as learned object candidates. The fully connected layer, like the meaning of a term, means that nodes in one layer are fully connected to nodes in the other layer. At this time, when using the binary learning parameter TPb of the inventive concept, the size of the parameter substantially consumed in the calculation of the fully connected layer, the complexity of the calculation, and the required system resources may be drastically reduced.

The calculation unit 130 may include a plurality of MAC cores 131, 132, . . . , 134 for processing a convolution layer calculation or a fully connected layer calculation in parallel. The calculation unit 130 may process the convolution operation with the kernel provided from the parameter buffer 150 and the input feature fragment stored in the input buffer 110 in parallel. Particularly, when using the binary learning parameter TPb of the inventive concept, a separate technique for processing binary data is required. The further configuration of such a calculation unit 130 will be described in detail with reference to the following drawings.

Parameters necessary for convolution calculation, bias addition, activation (ReLU), and pooling performed in the calculation unit 130 are provided to the parameter buffer 150. The parameter buffer 150 may provide the calculation unit 130 with the real learning parameter TPr provided from an external memory (not shown) at the time of calculation corresponding to the convolution layer. Especially, the parameter buffer 150 may provide the calculation unit 130 with the binary learning parameter TPb provided from an external memory (not shown) at the time of calculation corresponding to the fully connected layer.

The real learning parameter TPr may be a weight between learned nodes of the convolution layer. The binary learning parameter TPb may be learned weights between the nodes of the fully connected layer. The binary learning parameter TPb may be provided as a value obtained by converting the real weights of the fully connected layer obtained through learning into a binary value. For example, if the learned real weight of the fully connected layer is greater than zero, it may be mapped to the binary learning parameter TPb ‘1’. Alternatively, if the learned real weight of the fully connected layer is less than zero, it may be mapped to the binary learning parameter TPb ‘−1’. Through the conversion to the binary learning parameter TPb, the learning parameter size of the fully connected layer, which requires a large buffer capacity, may be drastically reduced.

The output buffer 170 is loaded with the results of the convolution layer calculation or the fully connected layer calculation performed by the calculation unit 130. The output buffer 170 may have a buffer size for storing the output features of the calculation unit 130. The required size of the output buffer 170 may also be reduced according to the application of the binary learning parameter TPb. Moreover, according to the application of the binary learning parameter TPb, the channel bandwidth requirement of the output buffer 170 and the external memory may be reduced.

In the above, the technique of using the binary learning parameter TPb as the weight of the fully connected layer has been described. And, it has been described that the real learning parameter TPr is used as the weight of the convolution layer. However, the inventive concept is not limited thereto. It will be understood by those skilled in the art that the weight of the convolution layer may be provided as the binary learning parameter (TPb).

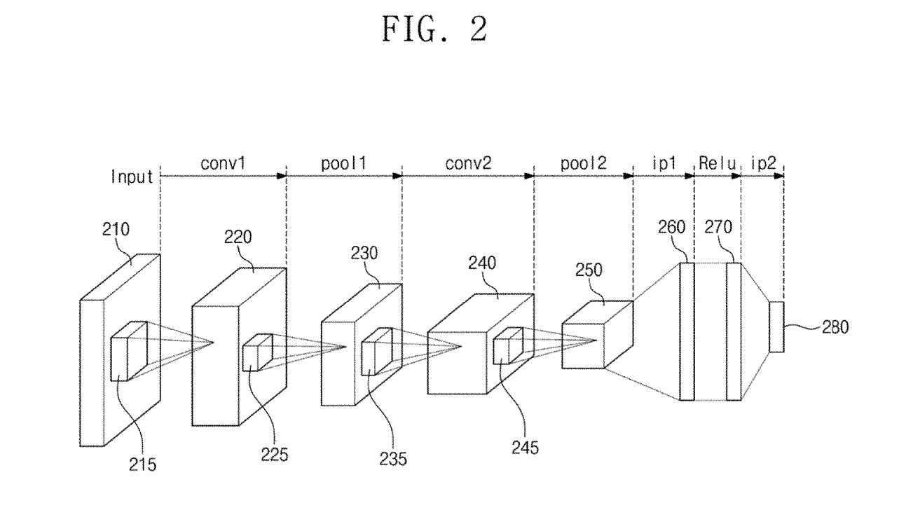

FIG. 2 is an exemplary view of CNN layers according to an embodiment of the inventive concept. Referring to FIG. 2, layers of a CNN for processing input features 210 are illustratively shown.

An enormous number of parameters should be inputted and updated in convolution or pooling calculations performed in operations such as learning or object recognition, and activation calculations and fully connected layer calculations. The input feature 210 is processed by a first convolution layer conv1 and a first pulling layer pool1 for down-sampling the result. When the input feature 210 is provided, the first convolution layer conv1, which performs a convolution calculation with the kernel 215, is applied first. That is, the data of the input feature 210 overlapping with the kernel 215 is multiplied with the data defined in the kernel 215. And all the multiplied values will be summed and generated as one feature value to configure one point of the first feature map 220. Such a kernelling calculation will be repeatedly performed as the kernel 215 is sequentially shifted.

Convolution calculation for one input feature 210 is performed on a plurality of kernels. And the first feature map 220 in the form of an array corresponding to each of the plurality of channels may be generated according to the application of the first convolution layer conv1. For example, when four kernels are used, the first feature map 220 configured using four channels may be generated.

Subsequently, down-sampling is performed to reduce the size of the first feature map 220 when execution of the first convolution layer conv1 is completed. The data of the first feature map 220 may be a size that is burdensome for processing depending on the number of kernels or the size of the input feature 210. Therefore, in the first pulling layer pool 1, down-sampling (or sub-sampling) is performed to reduce the size of the first feature map 220 within a range that does not significantly affect the calculation result. A typical calculation method of down-sampling is pooling. A maximum value or an average value in a corresponding area may be selected while a filter for down-sampling is slid with a predetermined stride in the first feature map 220. The case where the maximum value is selected is called a maximum pooling, and the method of outputting an average value is called an average pooling. The first feature map 220 is generated into a size-reduced second feature map 230 by the pooling layer pool1.

The convolution layer in which the convolution calculation is performed and the pooling layer in which the down-sampling calculation is performed may be repeated as necessary. That is, as shown in the drawing, a second convolution layer conv2 and a second pooling layer pool2 may be performed. A third feature map 240 may be generated through the second convolution layer conv2 and a fourth feature map 250 may be generated by the second pooling layer pool2. And, in relation to the fourth feature map 250, the fully connected layers 260 and 270 and the output layer 280 are generated through the processing of the fully connected layers ip1 and ip2 and the processing of the activation layer Relu, respectively. Of course, although not shown in the drawing, a bias addition or activation calculation may be added between the convolution layer and the pooling layer.

The output feature 280 is generated through the processing of the input feature 210 in the above-described CNN. In CNN learning, an error backpropagation algorithm may be used to back-propagate the weight error in the direction of minimizing the difference value between the result value and the expected value of such an operation. Through Gradient Descent technique at the learning calculation, the calculation of finding the optimal solution is repeated in the direction that errors of the learning parameters of each layer belonging to a CNN are minimized. In such a manner, the weights converge to real learning parameters through the learning process. The acquisition of this learning parameter is applied to all the layers of the CNN shown in the drawing. Weights of the convolutional layers conv1 and conv2 or the fully connected layers ip1 and ip2 may also be obtained as real values through this learning process.

In the inventive concept, when learning parameters in the fully connected layers ip1 and ip2 are obtained, they are converted into binary values for the learning parameters of a real value. That is, the weights between the nodes applied to the fully connected layers ip1 and ip2 are mapped to one of ‘−1’ or ‘1’ of the binary weight. At this time, the conversion to the binary weight may be performed, for example, through a method of mapping the real weight greater than or equal to ‘0’ to a binary weight of ‘1’ and mapping the real weight less than ‘0’ to a binary weight of ‘−1’. For example, if the weight of any one of the fully connected layers is a real value of ‘−3.5’, this value may be mapped to a binary weight of ‘−1’. However, it will be understood that the method of mapping the real weights to the binary weights is not limited to the description herein.

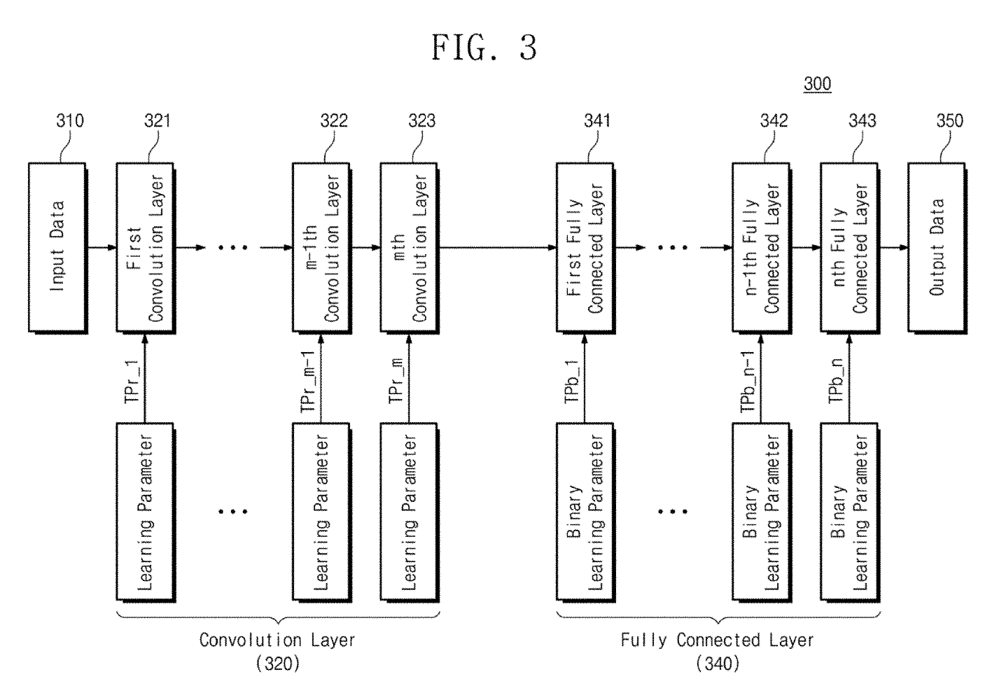

FIG. 3 is a block diagram briefly illustrating a method of applying learning parameters of the inventive concept. Referring to FIG. 3, input data 310 is processed by convolution layers 320 and fully connected layers 340 of the inventive concept and outputted as output data 350.

The input data 310 may be an input image or an input feature provided for object recognition. The input data 310 is processed by a plurality of convolution layers 321, 322, and 323, each characterizing real learning parameters TPr_1 to TPr_m. A real learning parameter TPr_1 will be provided from an external memory (not shown) to the parameter buffer 150 (see FIG. 1). And, it is delivered to the calculation unit 130 (see FIG. 1) for calculation of the first convolution layer 321. In the calculation of the first convolution layer 321 by the calculation unit 130, a real learning parameter TPr_1 may be a kernel weight. The feature map generated according to the execution of the calculation loop of the first convolution layer 321 will be provided as an input feature of the subsequent convolution layer calculation. The input data 310 is outputted in a pattern indicating the characteristic by the real learning parameters TPr_1 to TPr_m provided to each of the calculations of the plurality of convolution layers 321, 322, and 323.

The characteristics of the feature map generated as a result of the execution of the calculations of the plurality of convolution layers 321, 322, and 323 are classified by the plurality of fully connected layers 341, 342, 343. In the plurality of fully connected layers 341, 342 and 343, binary learning parameters TPb_1, . . . , TPb_n−1, TPb_n are used. Each of the binary learning parameters TPb_1, TPb_n−1, TPb_n should be obtained as a real value through a learning calculation and then converted to a binary value. Then, the converted binary learning parameters TPb_1, . . . , TPb_n−1, TPb_n are stored in the memory and then provided to the parameter buffer 150 at the time when the calculation of the fully connected layer 341, 342 and 343 is performed.

The feature map generated according to the execution of the calculation of the first fully connected layer 341 will be provided as an input feature of the subsequent fully connected layer. The binary learning parameters TPb_1 to TPb_n are used in each of the calculation of the plurality of fully connected layer 341, 342, and 343, and the output data 350 is generated.

The node connection between the layers of each of the plurality of fully connected layers 341, 342, and 343 has a fully connected structure. Thus, the learning parameters corresponding to the weights between the plurality of fully connected layers 341, 342, and 343 have a very large size if provided in real numbers. On the other hand, when provided as binary learning parameters TPb_1 to TPb_n of the inventive concept, the size of the weight may be reduced by a large ratio. Thus, when implementing hardware to implement the plurality of fully connected layers 341, 342, and 343, the size of the required calculation unit 130, parameter buffer 150, and output buffer 170 will also be reduced. In addition, the bandwidth or size of an external memory for storing and supplying the binary learning parameters TPb_1 to TPb_n may be reduced. In addition, when the binary learning parameters TPb_1 to TPb_n are used, the power consumed by the hardware is expected to be drastically reduced.

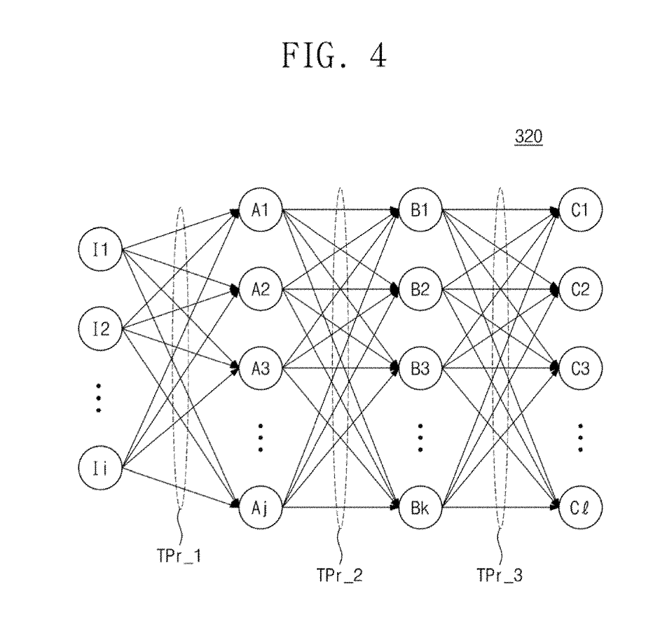

FIG. 4 is a view briefly illustrating the node structure of the convolution layer 320 of FIG. 3. Referring to FIG. 4, a learning parameter for defining a weight between nodes constituting the convolution layer 320 is provided as a real value.

If input features I1, I2, . . . , Ii (i is a natural number) are provided to the convolution layer 320, they are connected to nodes A1, A2, . . . , Aj (j is a natural number) with a predetermined weight by the real learning parameter TPr_1. And, the nodes A1, A2, . . . , Aj constituting the convolution layer are connected to nodes B1, B2, . . . , Bk (k is a natural number) constituting a convolution layer described later with a connection strength of a real learning parameter TPr_2. The nodes B1, B2, . . . , Bj constituting the convolution layer are connected to nodes C1, C2, . . . , C1 (1 is a natural number) constituting a convolution layer described later with a weight of a real learning parameter TPr_3.

The nodes constituting each convolution layer multiply the input features by the weights provided as the real learning parameters, and then sum and output the results. The convolution layer calculation of these nodes will be processed in parallel by the MAC cores constituting the calculation unit of FIG. 1 described above.

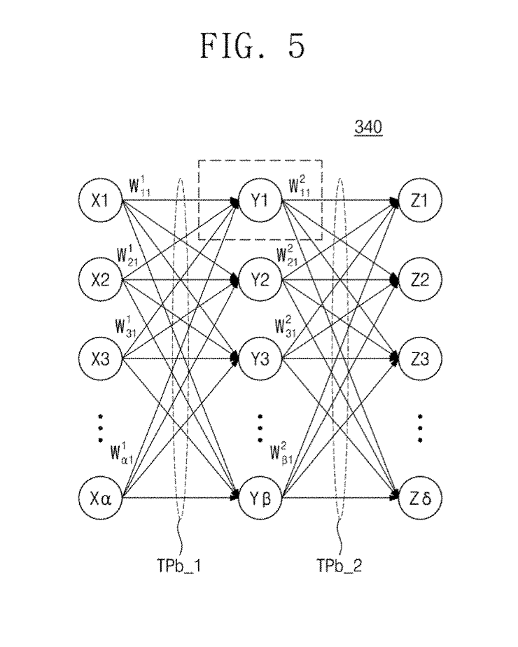

FIG. 5 is a view briefly illustrating the node structure of the fully connected layer of FIG. 3. Referring to FIG. 5, a learning parameter defining a weight between nodes constituting a fully connected layer 340 is provided as binary data.

Nodes X1, X2, . . . , Xα (α is a natural number) constituting a first fully connected layer are respectively connected to nodes Y1, Y2, . . . , Yβ (β is a natural number) constituting a second fully connected layer with a weight defined by a binary learning parameter TPb_1. The nodes X1, X2, . . . , Xα (α is a natural number) may be output features of the previously-performed convolution layer 320, respectively. The binary learning parameter TPb_1 may be provided after stored in an external memory such as a RAM (RAM). For example, the node X1 constituting the first fully connected layer and the node Y1 constituting the second fully connected layer may be connected to a weight W111 provided as the binary learning parameter. The node X2 constituting the first fully connected layer and the node Y1 constituting the second fully connected layer may be connected to a weight W121 provided as the binary learning parameter. Furthermore, the node Xα constituting the first fully connected layer and the node Y1 constituting the second fully connected layer may be connected to a weight W1α1 provided as the binary learning parameter. These weights W111, W121, . . . , W1α1 are all binary learning parameters having a value of ‘−1’ or ‘1’.

Nodes Y1, Y2, . . . , Yβ (β is a natural number) constituting the second fully connected layer are respectively connected to nodes Z1, Z2, . . . , Zδ (δ is a natural number) constituting a third fully connected layer with a weight defined by a binary learning parameter TPb_2. The node Y1 and the node Z1 may be connected to a weight W211 provided as the binary learning parameter. The node Y1 and the node Z1 may be connected to a weight W211 provided as the binary learning parameter. Furthermore, the node Yβ and the node Z1 may be connected to a weight W2β1 provided as the binary learning parameter. These weights W211, W221, . . . , W2β1 are all binary learning parameters having a value of ‘−1’ or ‘1’.

The nodes X1, X2, . . . , Xα constituting the first fully connected layer and the nodes Y1, Y2, . . . , Yβ constituting the second fully connected layer are connected to each other, each with a weight without exception. That is, each of the nodes X1, X2, . . . , Xα is connected to each of the nodes Y1, Y2, . . . , Yβ to have a learned weight. Thus, in order to provide a weight of a fully connected layer as a real learning parameter, it takes a tremendous amount of memory resources. However, when the binary learning parameter of the inventive concept is applied, the required memory resources, the sizes of the calculation unit 130, the parameter buffer 150, the output buffer 170, and the power consumed in the calculation are greatly reduced.

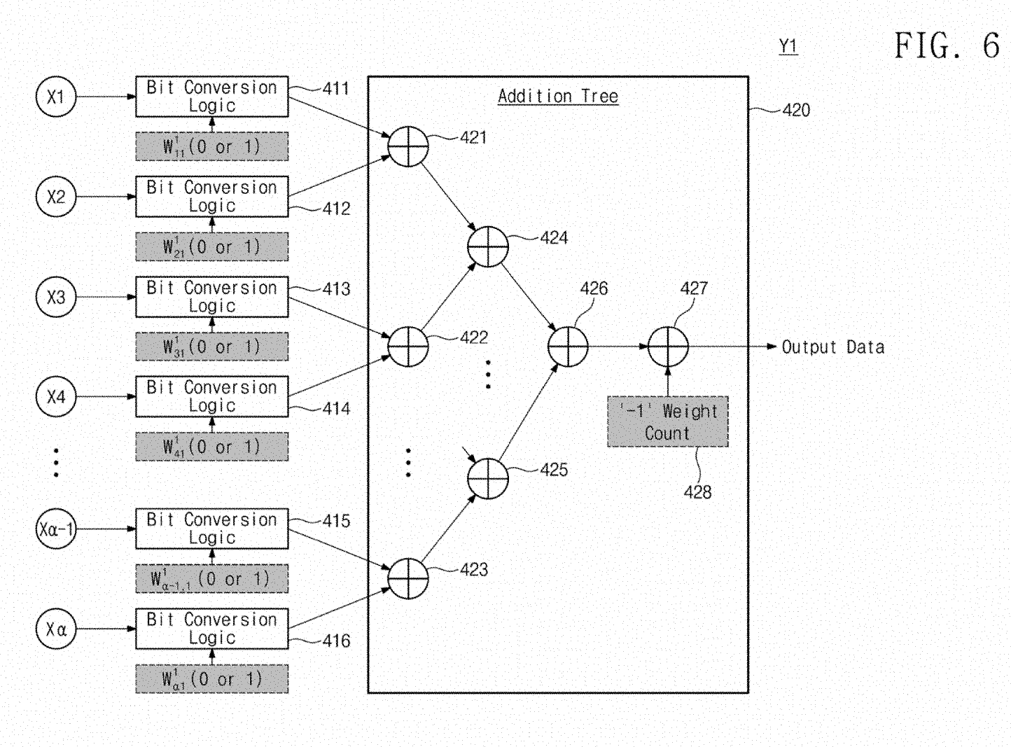

In addition, when binary learning parameters are used, the hardware structure of each node may be changed to a structure for processing binary parameters. The hardware structure of one node Y1 constituting such a fully connected layer will be described with reference to FIG. 6.

FIG. 6 is a block diagram illustrating a node structure of a fully connected layer according to an embodiment of the inventive concept. Referring to FIG. 6, one node is processed by bit conversion logics 411, 412, 413, 414, 415, and 416 that multiply the input features X1, X2, . . . , Xα with binary learning parameters and is provided to an addition tree 420.

The bit conversion logics 411, 412, 413, 441, 415, and 416 multiply the binary learning parameter allocated to each of the input features X1, X2, . . . , Xα having real values and deliver them to the addition tree 420. For simplification of binary calculations, a binary learning parameter having a value of ‘−1’ and ‘1’ may be converted to a value of logic ‘0’ and logic ‘1’. That is, the binary learning parameter ‘−1’ will be provided as a logic ‘0’ and the binary learning parameter ‘1’ will be provided as a logic ‘1’. Such a function may be performed by a weight decoder (not shown) provided separately.

When the logic structure of the fully connected layer is described more specifically, the input feature X1 is multiplied by the binary learning parameter W111 through the bit conversion logic 411. The binary learning parameter W111 at this time is a value converted into a logic ‘0’ and a logic ‘1’. When the binary learning parameter W111 is a logic ‘1’, the input value X1, i.e., a real value, is converted to a binary value and delivered to the addition tree. On the other hand, when the binary learning parameter W111 is a logic ‘0’, an effect of multiplying ‘−1’ should be provided. Accordingly, when the binary learning parameter W111 is a logic ‘0’, the bit conversion logic 411 converts the input feature X1, i.e., a real value, to a binary value, and adds 2's complement of the converted binary value to the addition tree 420. However, for efficiency of addition calculation, the bit conversion logic 411 converts the input feature X1 to a binary value and then performs conversion (or bit value inversion) to 1's complement and passes it to the addition tree 420, and a 2's complement effect may be performed in a ‘−1’ weight count 427 in the addition tree 420. That is, the 2's complement effect may be provided by summing all the numbers of ‘−1’ and adding a logic ‘1’ by the number of ‘−1’ at the end of the addition tree 420.

The function of the bit conversion logic 411 described above applies equally to the remaining bit conversion logics 412, 413, 414, 415, and 416. Each of the input features X1, X2, . . . , Xα of a real value may be converted to a binary value by the bit conversion logics 411, 412, 413, 414, 415, and 416 and then, provided to the addition tree 420. At this time, the binary learning parameters W111 to W1α1 are applied to the input features X1, X2, . . . , Xα converted to binary data and delivered to the addition tree 420. In the addition tree 420, the binary values of the features delivered by the plurality of adders 421, 422, 423, 425, and 426 are added. And, a 2's complement effect may be provided by the adder 427. A logic ‘1’ may be added by the number of ‘−1s’ among the binary learning parameters W111 to W1α1.

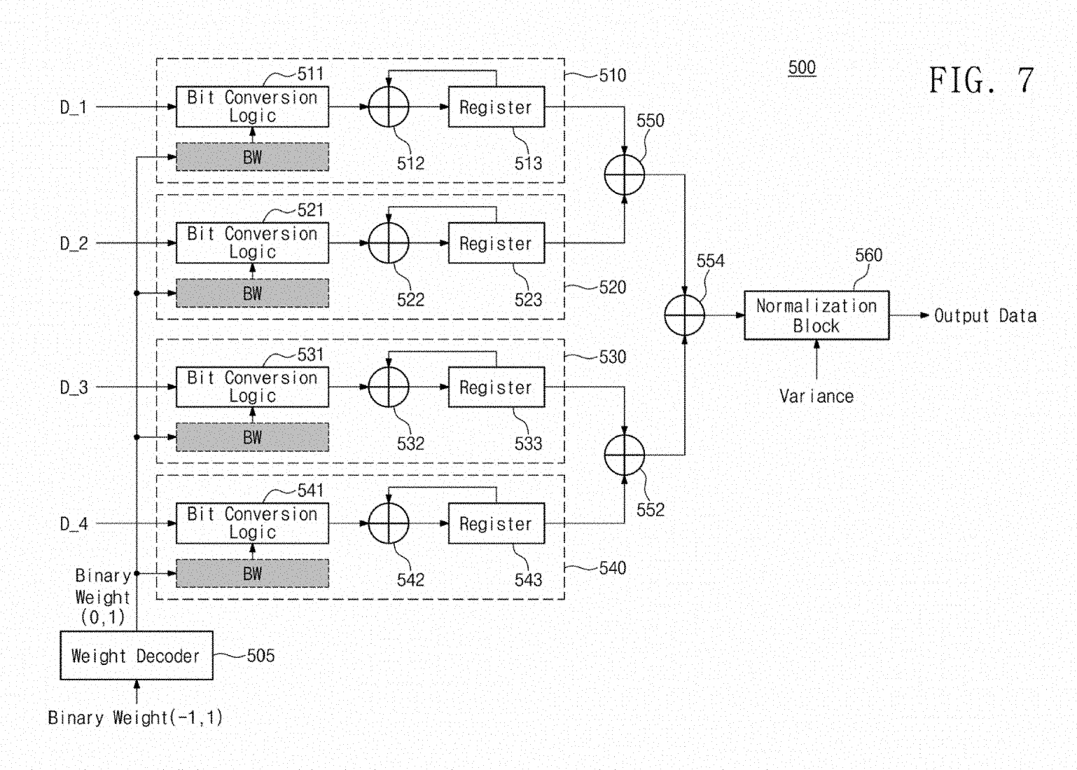

FIG. 7 is a block diagram illustrating an example of a hardware structure for executing the logic structure of FIG. 6 described above. Referring to FIG. 7, one node Y1 of the fully connected layer may be implemented as hardware in compressed form through a plurality of node calculation elements 510, 520, 530 and 540, adders 550, 552 and 554, and a normalization block 560.

According to the logic structure of FIG. 6 described above, bit conversion and weight multiplication of each of all inputted input features should be performed. Then, an addition should be performed on each of the result values to which bit conversion and weight are performed. As a result, it is understood that the bit conversion logics 411, 412, 413, 414, 415, and 416 corresponding to all input features should be configured and a large number of adders are required to add the output value of each of the bit conversion logics. In addition, the bit conversion logics 411, 412, 413, 414, 415, and 416 and the adders should operate simultaneously in parallel to obtain an errorless output value.

To solve the above issues, the hardware structure of the node of the inventive concept may be controlled to serially process input features using a plurality of node calculation elements 510, 520, 530, and 540. That is, the input features X1, X2, . . . , Xα may be arranged in input units (e.g., four units). Then, the input features X1, X2, . . . , Xα arranged in input units may be sequentially input into the four input units D_1, D_2, D_3, and D_4. That is, the input features X1, X5, X9, X13, . . . may be sequentially inputted to a first node calculation element 510 via an input terminal D_1. That is, the input features X2, X6, X10, X14, . . . may be sequentially inputted to a second node calculation element 520 via an input terminal D_2. That is, the input features X3, X7, X11, X15, . . . may be sequentially inputted to a third node calculation element 530 via an input terminal D_3. That is, the input features X4, X8, X12, X16, . . . may be sequentially inputted to a fourth node calculation element 540 via an input terminal D_4.

In addition, the weight decoder 505 converts the binary learning parameters (‘−1’, ‘1’) provided from the memory to logic learning parameters (‘0’, ‘1’) and provides them to the plurality of node calculation elements 510, 520, 530, and 540. At this time, the logic learning parameters (‘0’, ‘1’) will be sequentially provided to the bit conversion logics 511, 512, 513, and 514, four by four, in synchronization with each of four input features.

Each of the bit conversion logics 511, 512, 513, and 514 will convert sequentially-inputted four-unit real input features to binary feature values. If the provided logical weight is a logic ‘0’, each of the bit conversion logics 511, 512, 513, and 514 converts an inputted real number feature to a binary logical value, and converts the converted binary logic value with 1's complement and outputs it. On the other hand, if the provided logical weight is a logic ‘1’, each of the bit conversion logics 511, 512, 513 and 514 will convert the inputted real number feature to a binary logic value and output it.

The data outputted by the bit conversion logics 511, 512, 513, and 514 will be accumulated by adders 512, 522, 532, and 542 and registers 513, 523, 533, and 543. If all the input features corresponding to one layer are processed, the registers 513, 523, 533, and 543 output the summed result values and are added by the adders 550, 552, and 554. The output of the adder 554 is processed by a normalization block 560. The normalization block 560, for example, may provide an effect similar to the above-described calculation for adding the weight count of ‘−1’ in a manner of normalizing the output of the adder 554 by referring to the mean and variance of the batch units of an inputted parameter. That is, the mean shift of the output of the adder 554, which occurs by taking 1's complement by the bit conversion logics 511, 512, 513, and 514, may be normalized by referring to the mean and variance of the batch obtained at the time of learning. That is, the normalization block 560 will perform a normalization calculation such that the average value of the output data is ‘0’.

One node structure for implementing the CNN of the inventive concept in hardware has been briefly described. Herein, although the advantages of the inventive concept have been described with an example of processing input features in four units, the inventive concept is not limited thereto. The processing unit of an input feature may be varied according to the characteristics of a fully connected layer applying binary learning parameters of the inventive concept or according to a hardware platform for implementation.

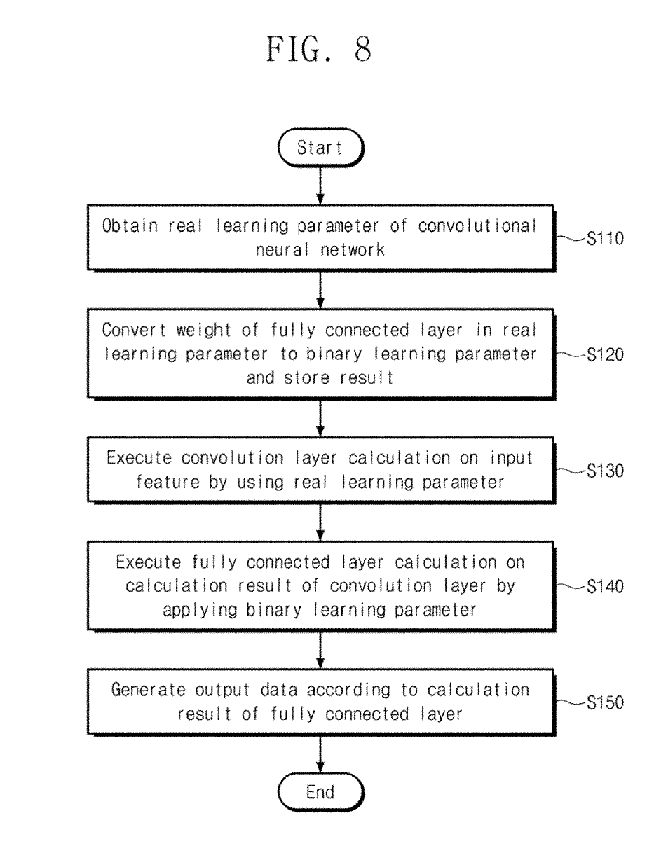

FIG. 8 is a flowchart briefly illustrating an operation method of a CNN system that applies a binary learning parameter according to an embodiment of the inventive concept. Referring to FIG. 8, an operation method of a CNN system using the binary learning parameter of the inventive concept will be described.

In operation S110, learning parameters are obtained through the training of the CNN system. At this time, the learning parameters will include parameters (hereinafter referred to as convolution learning parameters) defining the connection strength between the nodes of the convolution layer and parameters (hereinafter referred to as FC learning parameters) defining the weights of the fully connected layer. Both the convolution learning parameter and the FC learning parameter will be obtained with real values.

In operation S120, the binarization processing of the FC learning parameters corresponding to the weights of the fully connected layer is performed. Each of the FC learning parameters provided as a real value is compressed through a binarization process, which is mapped to a value of either ‘−1’ or ‘1’. In the binarization process, for example, among the FC learning parameters, weights having a size of ‘0’ or more may be mapped to a positive number ‘1’. Then, among the FC learning parameters, weights having a value smaller than ‘0’ may be mapped to a negative value ‘−1’. In this way, as a result of the binarization process, the FC learning parameters may be compressed into binary learning parameters. The compressed binary learning parameters will be stored in memory (or external memory) to support the CNN system.

In operation S130, the identification operation of the CNN system is performed. First, a convolution layer calculation for the input feature (input image) is performed. In the convolution layer calculation, the real learning parameter will be used. In the convolution layer calculation, the amount of computation used in convolution layer calculation is larger than the amount of parameters. Therefore, even if the real learning parameter is applied as it is, it will not significantly affect the operation of the system.

In operation S140, data provided as a result of the convolution layer calculation is processed through a fully connected layer calculation. The previously-stored binary learning parameters are applied to a fully connected layer calculation. Most learning parameters of the CNN system are concentrated in a fully connected layer. Thus, when the weights of a fully connected layer are converted to binary learning parameters, the burden of a fully connected layer calculation and the resources of a buffer and a memory may be drastically reduced.

In operation 5150, the final data may be outputted to the outside of the CNN system according to the result of the fully connected layer calculation.

The operation method of the CNN system using binary learning parameters has been briefly described above. Learning parameters corresponding to weights of the fully connected layer among the learning parameters provided as real numbers are converted to binary data (‘−1’ or ‘1’) and processed. Of course, the structure of the hardware platform for applying such binary learning parameters also needs to be partially changed. Such a hardware structure has been briefly described with reference to FIG. 7.

According to embodiments of the inventive concept, the inventive concept may drastically reduce the size of learning parameters in a fully connected layer of a conventional CNN. In the case of reducing the weight of the fully connected layer and implementing a hardware platform of the CNN according to the inventive concept, the CNN may be simplified and power consumption may be drastically reduced.

Although the exemplary embodiments of the inventive concept have been described, it is understood that the inventive concept should not be limited to these exemplary embodiments but various changes and modifications can be made by one ordinary skilled in the art within the spirit and scope of the inventive concept as hereinafter claimed.

What is claimed is:

1. A convolutional neural network system comprising:
an input buffer configured to store an input feature;
a parameter buffer configured to store a learning parameter;
a calculation unit configured to perform a convolution layer calculation or a fully connected layer calculation by using the input feature provided from the input buffer and the learning parameter provided from the parameter buffer; and
an output buffer configured to store an output feature outputted from the calculation unit and output the stored output feature to the outside,
wherein the parameter buffer provides a real learning parameter to the calculation unit at the time of the convolution layer calculation and provides a binary learning parameter to the calculation unit at the time of the fully connected layer calculation.

2. The system of claim 1, wherein the binary learning parameter has a data value of either ‘−1’ or ‘1’.

3. The system of claim 2, wherein the binary learning parameter is generated by mapping a value equal to or greater than ‘0’ to ‘1’ and mapping a value less than ‘0’ to ‘−1’ among real weights of the fully connected layer determined through learning.

4. The system of claim 1, wherein the calculation unit comprises:
a plurality of bit conversion logics configured to multiply each of the plurality of input features by the corresponding binary learning parameter to be outputted as a logic value at the time of the fully connected layer calculation; and
an addition tree configured to add outputs of the plurality of bit conversion logics.

5. The system of claim 4, wherein each of the plurality of bit conversion logics converts each of the input features to binary data and multiplies the binary learning parameter by the converted binary data to deliver a result thereof to the addition tree.

6. The system of claim 5, wherein when the binary learning parameter is a logic ‘−1’, the binary learning parameter is converted in a 2's complement form of a corresponding input feature and deliver a result thereof to the addition tree.

7. The system of claim 6, wherein when the binary learning parameter is a logic ‘−1’, each of the plurality of bit conversion logics converts each of the input features to 1's complement and delivers a result thereof to the addition tree and the addition tree adds a count value of a logic ‘−1’ among the binary learning parameters.

8. The system of claim 1, wherein the calculation unit comprises:
a plurality of node calculation elements configured to sequentially process at least two input features among input features of the same layer at the time of the fully connected layer calculation according to a corresponding binary learning parameter;
an addition logic configured to add output values of the node calculation elements; and
a normalization block configured to normalize an output of the addition logic by referring to a mean and a variance of a batch unit.

9. The system of claim 8, wherein each of the plurality of node calculation elements comprises:
a bit conversion logic configured to convert each of the at least two input features to binary data and multiply each converted binary data by the corresponding binary learning parameter to sequentially output a result thereof; and
an adder-register unit configured to accumulate at least two binary data outputted sequentially from the bit conversion logic.

10. The system of claim 9, wherein the calculation unit further comprises a weight decoder configured to convert the binary learning parameter to a logic ‘0’ or a logic ‘1’ before supplying the binary learning parameter to each of the plurality of node calculation elements.

11. An operation method of a convolutional neural network system, the method comprising:
determining a real learning parameter through learning of the convolutional neural network system;
converting a weight of a fully connected layer of the convolutional neural network system in the real learning parameter to a binary learning parameter;
processing an input feature through a convolution layer calculation applying the real learning parameter; and
processing a result of the convolution layer calculation through a fully connected layer calculation applying the binary learning parameter.

12. The method of claim 11, wherein the binary learning parameter is converted to have a data value of either ‘−1’ or ‘1’.

13. The method of claim 12, wherein the processing through the fully connected layer calculation comprises converting inputted real data to binary data and multiplying the converted binary data by the binary learning parameter to output a result thereof.

14. The method of claim 13, wherein the calculation of multiplying the binary data by the binary learning parameter ‘−1’ comprises a conversion calculation with 2's complement of the binary data.

15. The method of claim 14, wherein the calculation of multiplying the binary data by the binary leaning parameter ‘−1’ comprises a calculation of converting the binary data to 1's complement and adding to the 1's complement by the number of the binary learning parameters ‘−1’.
